(19) United States
(12) Patent Application Publication
(10) Pub. No.: US 2026/0036991 A1
(43) Pub. Date: Feb. 5, 2026

(54) APPARATUS AND METHOD FOR GENERATING SEMANTIC MAP-BASED ROBOT DRIVING ROUTE PLAN FOR TRANSPORTATION VULNERABLE

(71) Applicants: HYUNDAI MOTOR COMPANY, Seoul (KR); KIA CORPORATION, Seoul (KR)

(72) Inventors: Sunwoo Lee, Hwaseong-si (KR); Yeongmin Song, Hwaseong-si (KR); Jaeseon Kim, Hwaseong-si (KR); Dongheon Shin, Hwaseong-si (KR)

(73) Assignees: HYUNDAI MOTOR COMPANY, Seoul (KR); KIA CORPORATION, Seoul (KR)

(21) Appl. No.: 18/953,984

(22) Filed: Nov. 20, 2024

(30) Foreign Application Priority Data
Jul. 30, 2024 (KR) 10-2024-0101179

(51) Int. Cl. G05D 1/622; G05D 1/246; G05D 1/65; G05D 105/20; G05D 111/10; G05D 111/50

(52) U.S. Cl. CPC G05D 1/637; G05D 1/2467; G05D 1/65; G05D 2105/20; G05D 2111/10; G05D 2111/52

(57) ABSTRACT

An apparatus for generating a semantic map-based robot driving route plan for transportation vulnerable includes: a semantic map generation unit configured to generate a semantic map for an area where a driving robot is driving based on real-time location tracking data of the driving robot and semantic data on a surrounding environment; a safety zone generation unit configured to calculate heights for a plurality of objects recognized while the driving robot is driving on the generated semantic map and generate a safety zone for a specific object determined to be the transportation vulnerable among the plurality of objects based on the heights; and a driving route plan generation unit configured to generate a second driving route plan different from a first driving route plan in real time for the safety zone when the safety zone is generated while the driving robot is driving with the first driving route plan.

### CROSS-REFERENCE TO RELATED APPLICATION

This application claims the priority to and the benefit of Korean Patent Application No. 10-2024-0101179 filed in the Korean Intellectual Property Office on Jul. 30, 2024, the entire contents of which are incorporated herein by reference.

### TECHNICAL FIELD

The present disclosure relates to an apparatus and a method for generating a semantic map-based robot driving route plan for transportation vulnerable to avoid the risk of collision between the transportation vulnerable and a driving robot.

### BACKGROUND

A semantic map plays an important role in helping a robot recognize and understand an environment. The semantic map helps a robot understand objects and their meanings in the environment, rather than simply recognizing obstacles or spaces. The semantic map significantly improves the robot's autonomy, interaction, and task performance capabilities.

A driving robot drives uses the semantic map to navigate. The driving robot should generate a driving route that avoids collisions with other objects while the driving robot is driving. When using the existing general semantic map, the driving robot drives along the previously set driving route regardless of the type of objects, so there is a risk of collision. The subject matter described in this background section is intended to promote an understanding of the background of the disclosure and thus may include subject matter that is not already known to those of ordinary skill in the art.

### SUMMARY

The present disclosure aims to provide an apparatus and a method for generating a semantic map-based robot driving route plan for transportation vulnerable. The apparatus and the method may generate a safety zone for transportation vulnerable detected below a specific height using height information and semantic information and may generate an optimal driving route plan for transportation vulnerable in the safety zone.

According to an embodiment of the present disclosure, an apparatus for generating a semantic map-based robot driving route plan for transportation vulnerable includes a semantic map generation unit configured to generate a semantic map for an area where a driving robot is driving based on real-time location tracking data of the driving robot and semantic data on a surrounding environment. The apparatus also includes a safety zone generation unit configured to calculate heights for a plurality of objects recognized while the driving robot is driving on the generated semantic map. The safety zone generation unit is also configured to generate a safety zone for a specific object determined to be the transportation vulnerable among the plurality of objects based on the heights. The apparatus also includes a driving route plan generation unit generating a second driving route plan different from a first driving route plan in real time for the safety zone when the safety zone is generated while the driving robot is driving with the first driving route plan.

The semantic map generation unit may generate the semantic map based on depth images obtained from a plurality of cameras, odometry of the driving robot estimated in real time from an IMU sensor, and a semantic image estimated from RGB images obtained from the plurality of cameras.

The safety zone generation unit may receive a semantic cloud generated from the semantic map; classify the semantic cloud into an instance unit through clustering; and calculate a height for a classified human class.

The safety zone generation unit may determine an object, having a height is smaller than a preset specific reference value, as the specific object.

The safety zone generation unit may variably determine a type of the safety zone based on the height of the specific object.

The safety zone generation unit may generate a first safety zone for a first specific object having height a smaller than a first reference value among the specific objects. The safety zone generation unit may generate a second safety zone for a second specific object having a height smaller than a second reference value among the specific objects. The second reference value is smaller than the first reference value.

The driving route plan generation unit may set an expected collision range for the safety zone and may generate the second driving route plan that detours the expected collision range.

The driving route plan generation unit may variably set the expected collision range according to the type of the safety zone. A size of the expected collision range may be inversely proportional to the height of the specific object.

The driving route plan generation unit may accelerate a driving speed of the driving robot while the driving robot is driving with the first driving route plan, and decelerate the driving speed while the driving robot is driving with the second driving route plan.

The driving route plan generation unit may variably determine a degree of deceleration of the driving speed of the driving robot in the second driving route plan based on a type of the safety zone that varies based on a height of the specific object.

According to another embodiment of the present disclosure, a method for generating a semantic map-based robot driving route plan for transportation vulnerable includes generating a semantic map for an area where a driving robot is driving based on real-time location tracking data of the driving robot and semantic data on a surrounding environment. The method also includes calculating heights for a plurality of objects recognized while the driving robot is driving on the generated semantic map. The method also includes generating a safety zone for a specific object determined to be the transportation vulnerable among the plurality of objects based on the heights. The method also includes generating a second driving route plan different from a first driving route plan in real time for the safety zone when the safety zone is generated while the driving robot is driving with the first driving route plan.

Generating the semantic map may include generating the semantic map based on depth images obtained from a plurality of cameras, odometry of the driving robot estimated in real time from an IMU sensor, and a semantic image estimated from RGB images obtained from the plurality of cameras.

Calculating the heights for the plurality of objects may include generating a semantic cloud from the semantic map; classifying the semantic cloud into an instance unit through clustering; and calculating a height for a classified human class.

Generating the safety zone may include determining an object, having a height smaller than a preset specific reference value, as the specific object.

Generating the safety zone may further include variably determining a type of the safety zone based on the height of the specific object.

Generating the safety zone may further include generating a first safety zone for a first specific object having a height smaller than a first reference value among the specific objects. Generating the safety zone may further include generating a second safety zone for a second specific object having a height smaller than a second reference value among the specific objects. The second reference value may be smaller than the first reference value.

Generating the second driving route plan in real time may include setting an expected collision range for the safety zone and generating the second driving route plan that detours the set expected collision range.

Generating the second driving route plan in real time may further include variably setting the expected collision range according to the type of the safety zone. A size of the expected collision range may be inversely proportional to the height of the specific object.

Generating the second driving route plan in real time may include accelerating a driving speed of the driving robot while the driving robot is driving with the first driving route plan. Generating the second driving route plan in real time may include decelerating the driving speed while the driving robot is driving with the second driving route plan.

Generating the second driving route plan in real time may further include variably determining a degree of deceleration of the driving speed of the driving robot in the second driving route plan based on a type of the safety zone that varies depending on a height of the specific object.

By using the apparatus and the method for generating a semantic map-based robot driving route plan for transportation vulnerable according to an embodiment of the present disclosure, it is possible to generate the optimal driving route plan by determining the information on the transportation vulnerable in advance to relieve the risk of collision with transportation vulnerable when the robot drives using the local map containing the semantic information.

### BRIEF DESCRIPTION OF THE DRAWINGS

FIG. 1 is a block diagram of an apparatus for generating a semantic map-based robot driving route plan for transportation vulnerable according to an embodiment of the present disclosure.

FIG. 2 is a flowchart of a method for generating a semantic map-based robot driving route plan for transportation vulnerable according to an embodiment of the present disclosure.

FIG. 3 is a flowchart illustrating a method for generating a safety zone according to an embodiment of the present disclosure.

FIG. 4 is a flowchart illustrating a method for generating a driving route plan according to an embodiment of the present disclosure.

FIG. 5 is a diagram illustrating a human instance according to an embodiment of the present disclosure.

FIG. 6 is a diagram illustrating an expected collision range for each safety zone according to an embodiment of the present disclosure.

FIG. 7A is a diagram illustrating an existing robot driving route plan according to a Comparative Example.

FIG. 7B is a diagram illustrating a robot driving route plan according to an embodiment of the present disclosure.

FIG. 8 is a diagram for describing a computing device according to an embodiment of present disclosure.

### DETAILED DESCRIPTION

Hereinafter, the present disclosure is described more fully hereinafter with reference to the accompanying drawings, in which embodiments of the present disclosure are shown. Those having ordinary skill in the art should realize that the described embodiments may be modified in various different ways, without departing from the spirit or scope of the present disclosure. Accordingly, the drawings and descriptions should be regarded as illustrative in nature and not restrictive. Like reference numerals designate same or like elements throughout the present disclosure.

Throughout the present disclosure, unless explicitly described to the contrary, the term “comprise” and variations, such as “comprises” or “comprising”, should be understood to include stated elements without excluding any other elements. Terms including an ordinal number, such as first, second, etc., may be used to describe various components, but the components are not limited to these terms. The above terms are used solely for the purpose of distinguishing one component from another.

Terms, such as “ . . . unit”, “ . . . er/or”, and “module” used in the specification, may mean a unit capable of processing at least one function or operation described in the specification, which may be implemented as hardware or a circuit, software, or a combination of hardware or circuit and software. When a controller, module, component, device, element, unit, part, portion, “ . . . er/or”, or the like of the present disclosure is described as having a purpose or performing an operation, function, or the like, the controller, module, component, device, element, unit, part, portion, “ . . . er/or”, or the like should be considered herein as being “configured to” meet that purpose or to perform that operation or function. Each controller, module, component, device, element, unit, part, portion, “ . . . er/or”, and the like may separately embody or be included with a processor and a memory, such as a non-transitory computer readable media, as part of the apparatus.

Hereinafter, embodiments of the present disclosure will be described with reference to the drawings.

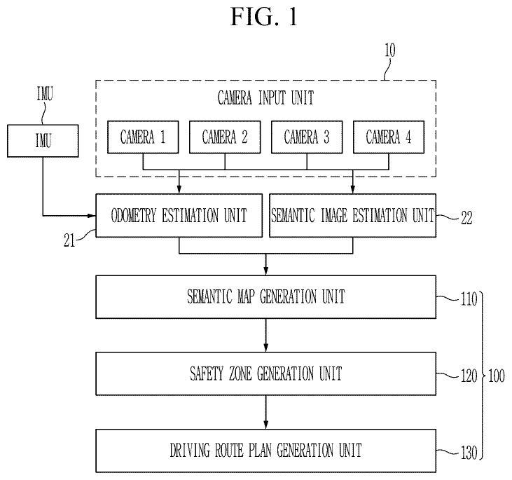

FIG. 1 is a block diagram of an apparatus for generating a semantic map-based robot driving route plan for transportation vulnerable according to an embodiment of the present disclosure.

The apparatus 100 for generating a robot driving route plan may generate a safety zone in real time for transportation vulnerable (e.g., children, infants, wheelchairs) detected below a specific height by using object height information and semantic information provided through a semantic map.

When the transportation vulnerable is detected in the safety zone, the apparatus 100 for generating a robot driving route plan may generate a new robot driving route plan for a driving robot, which is driving, and may control the driving robot to drive in the safety zone through the newly generated driving route plan.

For example, when the safety zone is generated, the apparatus 100 for generating a robot driving route plan may generate a robot driving route plan that reduces the driving speed of the driving robot, which is driving in the safety zone, and extends an expected collision range with the transportation vulnerable.

Referring to FIG. 1, the apparatus for generating a semantic map-based robot driving route plan (hereinafter, the apparatus 100 for generating a robot driving route plan) for transportation vulnerable may include a semantic map generation unit 110, a safety zone generation unit 120, and a driving route plan generation unit 130.

The apparatus 100 for generating a robot driving route plan may receive information necessary for generating a safety zone and a driving route plan from an inertial measurement unit sensor, a camera input unit 10, an odometry estimation unit 21, and a semantic image estimation unit 22 that are provided in the driving robot.

The IMU sensor (IMU) includes an accelerometer and a gyroscope, and each data may be used to calculate the movement of the robot.

In other words, the IMU sensor (IMU) may be used to estimate the odometry of the robot.

The camera input unit 10 may include a plurality of cameras including camera 1 to camera N.

The multiple cameras may include an RGB camera and a depth camera.

The camera input unit 10 may acquire RGB images and depth images captured by the plurality of cameras.

The odometry estimation unit 21 may estimate the location and orientation of the driving robot while the driving robot is driving.

The odometry may refer to data on the movement of the robot, including the location, movement distance, and change in orientation, etc., of the robot.

The odometry estimation unit 21 may receive data from the IMU sensor (IMU) and the camera input unit 10, may track the movement route of the robot, and may calculate the current location and direction.

For example, the odometry estimation unit 21 may estimate the location and orientation of the robot based on sensor data (mainly wheel encoder data) detected while the robot is moving.

The odometry estimation unit 21 may estimate the movement route and angle change of the robot and use the estimated movement route and angle change to update the location of the semantic map.

The semantic image estimation unit 22 may estimate a semantic image using the RGB image acquired from the camera input unit 10.

The semantic image is semantic information extracted from an image captured by the camera or other visual sensors.

The semantic image estimation unit 22 may capture images around the robot using an RGB-D camera or a general RGB camera.

The semantic image estimation unit 22 may recognize objects and their meanings in the image using a deep learning model and may classify each pixel into a corresponding class (e.g., person, chair, table, etc.).

The semantic image estimation unit 22 may project the environment around the robot onto the semantic map based on the semantic information extracted from the image.

The apparatus 100 for generating a robot driving route plan may be provided on the driving robot. In addition, the apparatus 100 for generating a robot driving route plan may be arranged separately from the driving robot.

When the apparatus 100 for generating a robot driving route plan is arranged separately from the driving robot, the apparatus 100 for generating a robot driving route plan may be connected to the IMU sensor (IMU), the camera input unit 10, the odometry estimation unit 21, and the semantic data estimation unit 22 of the driving robot through a network.

In FIG. 1, the semantic map generation unit 110 may generate the semantic map for an area where the driving robot is driving based on the real-time location tracking data of the driving robot and the semantic data for the surrounding environment.

The semantic map generation unit 110 may implement the semantic map using the odometry estimated through the odometry estimation unit 21 and the semantic image estimated through the semantic image estimation unit 22.

In other words, the semantic map generation unit 110 may generate the semantic map based on the depth images obtained from the plurality of cameras, the odometry of the driving robot estimated in real time from the IMU sensor, and the semantic image estimated from the RGB images obtained from the plurality of cameras.

For example, the semantic map generation unit 110 may use a simultaneous localization and mapping (SLAM) algorithm (e.g., semantic SLAM) that includes the semantic information. In other words, the semantic map generation unit 110 may generate the semantic map in real time by simultaneously using the estimated location of the driving robot and the detected object while the driving robot moves.

The semantic map generation unit 110 may generate a semantic cloud that visualizes the semantic information generated through semantic local mapping.

The safety zone generation unit 120 may calculate heights for a plurality of objects recognized while the driving robot is driving on the generated semantic map. The safety zone generation unit 120 may generate a safety zone for a specific object determined to be the transportation vulnerable among the plurality of objects based on the calculated heights.

Hereinafter, the specific object may mean the transportation vulnerable. The transportation vulnerable may include children, infants, and disabled people in wheelchair.

The safety zone generation unit 120 may implement a safety zone of a certain range for a specific object at a location of a specific object. In other words, the safety zone generation unit 120 may consider a specific object or an area occupied by the specific object as the safety zone.

The safety zone generation unit 120 may receive the semantic cloud generated from the semantic map.

The safety zone generation unit 120 may classify the semantic cloud into instance units through clustering and may calculate a height for the classified human classes.

Among the classified human classes, the safety zone generation unit 120 may determine or identify an object, having a height smaller than a preset specific reference value, as a specific object that is transportation vulnerable.

Here, the preset specific reference value is determined based on the height of the human classified as the transportation vulnerable. For example, the specific reference value may be 140 cm, which is an average height of children.

A person with a height smaller than 140 cm may include a child, an infant, or a disabled person in a wheelchair.

In other words, the safety zone generation unit 120 may determine a person object, having a height smaller than 140 cm, as a specific object. In other words, the specific object may be an object determined to be a child, an infant, or a disabled person in a wheelchair.

The safety zone generation unit 120 may variably determine a type of safety zones based on the height of the specific object.

The safety zone generation unit 120 may determine the type of safety zones differently based on the height difference among the specific objects.

The safety zone generation unit 120 may generate a first safety zone for a first specific object, among the specific objects, that has a height smaller than the first reference value.

For example, the safety zone generation unit 120 may generate the first safety zone for the first specific object having a height smaller than 140 cm.

The safety zone generation unit 120 may generate a second safety zone for a second specific object, among the specific objects, that has a height smaller than a second reference value. Here, the second reference value may be smaller than the first reference value.

For example, the safety zone generation unit 120 may generate the second safety zone for the second specific object having a height smaller than 120 cm.

The first safety zone and the second safety zone may have different expected collision ranges.

The driving route plan generation unit 130 may generate a second driving route plan different from the first driving route plan for the safety zone in real time when the safety zone is generated while the driving robot is driving with the first driving route plan.

The driving route plan generation unit 130 may set the expected collision range for the safety zone and may generate the second driving route plan that detours the expected collision range.

The driving route plan generation unit 130 may variably set the expected collision range according to the type of safety zones. The size of the expected collision range may be inversely proportional to the height of the specific object. For example, the first expected collision range of the first safety zone may be smaller than the second expected collision range of the second safety zone.

The driving route plan generation unit 130 may accelerate the driving speed of the driving robot while the driving robot is driving with the first driving route plan. The driving route plan generation unit 130 may decelerate the driving speed of the driving robot while the driving robot is driving with the second driving route plan.

In other words, the driving route plan generation unit 130 may reduce the driving speed of the driving robot when the driving robot is driving in the safety zone.

The driving route plan generation unit 130 may variably determine the degree of deceleration of the driving speed of the driving robot in the second driving route plan based on the type of safety zones that vary based on the height of the specific object.

For example, the driving route plan generation unit 130 may determine the second driving speed of the driving robot in the second safety zone to be smaller than the first driving speed of the driving robot in the first safety zone. In other words, the driving route plan generation unit 130 may determine the degree of deceleration of the driving speed in the second safety zone to be greater than the degree of deceleration of the driving speed in the first safety zone.

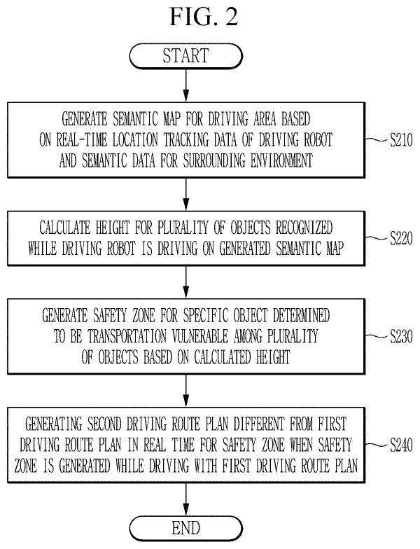

FIG. 2 is a flowchart of a method for generating a semantic map-based robot driving route plan for transportation vulnerable according to an embodiment of the present disclosure.

The method for generating a semantic map-based robot driving route plan for transportation vulnerable of FIG. 2 may be performed through the apparatus 100 for generating a semantic map-based robot driving route plan for transportation vulnerable of FIG. 1.

In FIG. 2, the apparatus 100 for generating a robot driving route plan may generate the semantic map for the area where the driving robot is driving based on the real-time location tracking data of the driving robot and the semantic data for the surrounding environment (step S210).

In an embodiment, the apparatus 100 for generating a robot driving route plan may generate the semantic map based on the depth images obtained from the plurality of cameras, the odometry of the driving robot estimated in real time from the IMU sensor, and the semantic images estimated from the RGB images obtained from the plurality of cameras.

The apparatus 100 for generating a robot driving route plan may calculate the heights for the plurality of objects recognized while the driving robot is driving on the generated semantic map (step S220).

The apparatus 100 for generating a robot driving route plan may generate the safety zone for the specific object determined to be the transportation vulnerable among the plurality of objects based on the calculated heights (step S230).

The apparatus 100 for generating a robot driving route plan may generate the second driving route plan different from the first driving route plan in real time for the safety zone when the safety zone is generated while the driving robot is driving with the first driving route plan (step S240).

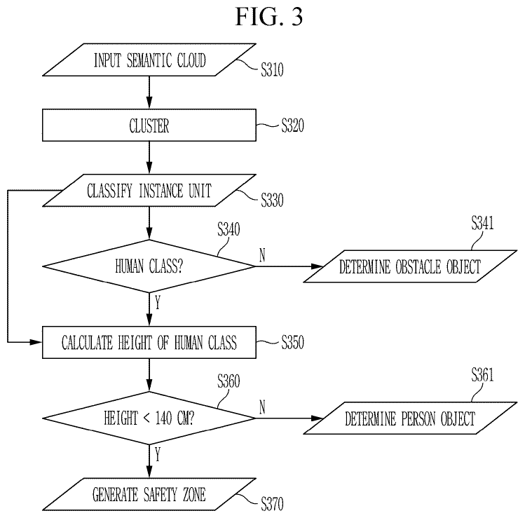

FIG. 3 is a flowchart illustrating a method for generating a safety zone according to an embodiment of the present disclosure.

The method for generating a safety zone of FIG. 3 may be performed through the apparatus 100 for generating a semantic map-based robot driving route plan for transportation vulnerable of FIG. 1. For example, the method for generating a safety zone of FIG. 3 may be performed through the safety zone generation unit 120 of FIG. 1.

In FIG. 3, the apparatus 100 for generating a robot driving route plan may generate the semantic cloud from the semantic map (step S310).

When the semantic cloud is input, the apparatus 100 for generating a robot driving route plan may classify the semantic cloud into the object units or instance units through the clustering (step S320) (step S330).

The apparatus 100 for generating a robot driving route plan may classify human objects and obstacle objects, i.e., determine whether the instances are classified as the human class (step S340).

The apparatus 100 for generating a robot driving route plan may determine all the instances other than the human class (N in step S340) as the obstacle objects (step S341).

The apparatus 100 for generating a robot driving route plan may calculate the height for the human class (step S350) when the instances are classified as the human class (Y in step S340).

The apparatus 100 for generating a robot driving route plan may determine whether the calculated height is smaller than the specific reference value (step S360). For example, the apparatus 100 for generating a robot driving route plan determines whether the height of the calculated human class is smaller than 140 cm.

The apparatus 100 for generating a robot driving route plan may determine an object, having a height smaller than a preset specific reference value, as a specific object (Y in step S360). The apparatus 100 for generating a robot driving route plan may generate the safety zone for the specific object (step S370).

The apparatus 100 for generating a robot driving route plan determines an object, having height greater than or equal to 140 cm (N in step S360), as a human object (S361). Here, the human object may include a person who is not classified as the specific object among people. In other words, the human object may be a student or an adult.

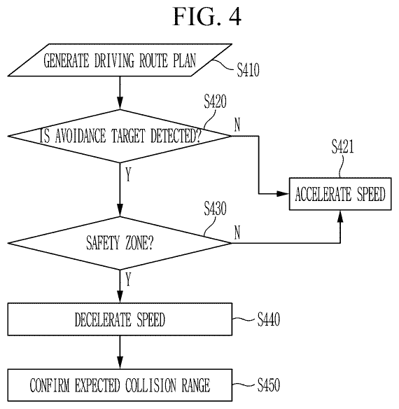

FIG. 4 is a flowchart illustrating a method for generating a driving route plan according to an embodiment of the present disclosure.

The method for generating a driving route plan of FIG. 4 may be performed through the apparatus 100 for generating a semantic map-based robot driving route plan for transportation vulnerable of FIG. 1. For example, the method for generating a driving route plan of FIG. 4 may be performed through the driving route plan generation unit 130 of FIG. 1.

In FIG. 4, the apparatus 100 for generating a robot driving route plan may generate the driving route plan based on the semantic map (step S410). The driving route plan may include a first driving route plan and a second driving route plan.

The apparatus 100 for generating a robot driving route plan may determine whether an avoidance target while the robot is driving is detected (step S420). The avoidance target may be an obstacle object, a human object, or a specific object (safety zone).

The apparatus 100 for generating a robot driving route plan may determine whether the avoidance target is the safety zone (step S430) when the avoidance target while the robot is driving is detected (Y in step S420). Alternatively, the apparatus 100 for generating a robot driving route plan may generate the safety zone in real time based on the height and semantic information for the detected avoidance target.

The apparatus 100 for generating a robot driving route plan may accelerate the driving speed of the driving robot (step S421) when the avoidance target is not detected or when the detected avoidance target is determined not to be the safety zone (or when the safety zone is not generated) (N in step S420).

In other words, the apparatus 100 for generating a robot driving route plan may generate the first driving route plan that accelerates the driving speed of the driving robot and drive the driving robot accordingly.

The apparatus 100 for generating a robot driving route plan may generate a previously set expected collision range for the object that is the avoidance target detected according to the first driving route plan.

The apparatus 100 for generating a robot driving route plan may decelerate the driving speed of the driving robot (step S440) when the avoidance target is determined to be the safety zone (or the safety zone is generated for the avoidance target) (Y in step S420).

That is, the apparatus 100 for generating a robot driving route plan may generate the second driving route plan for the safety zone and decelerate the driving robot accordingly.

The apparatus 100 for generating a robot driving route plan may set the expected collision range for the safety zone (step S450).

The apparatus 100 for generating a robot driving route plan may control the driving of the driving robot according to the second driving route plan that is generated based on the set expected collision range.

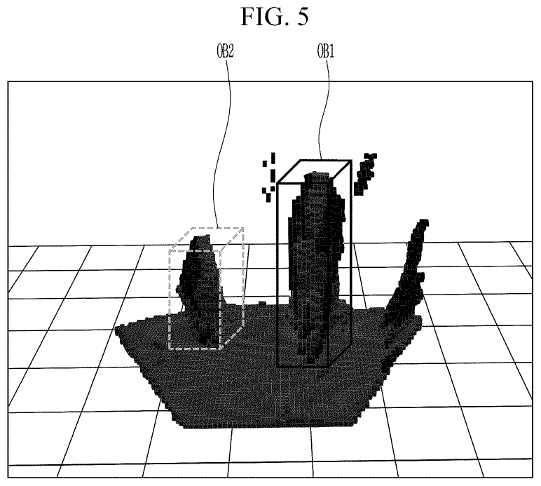

FIG. 5 is a diagram illustrating a human instance according to an embodiment of the present disclosure. FIG. 5 is a diagram of the human instance on the semantic map.

In FIG. 5, the human instance may be classified into a human object OB1 and a specific object OB2. The human instance, having a height 140 cm or more, is determined as the human object OB1, and the human instance, having a height smaller than 140 cm, is determined as the specific object OB2, which may be considered as a safety zone.

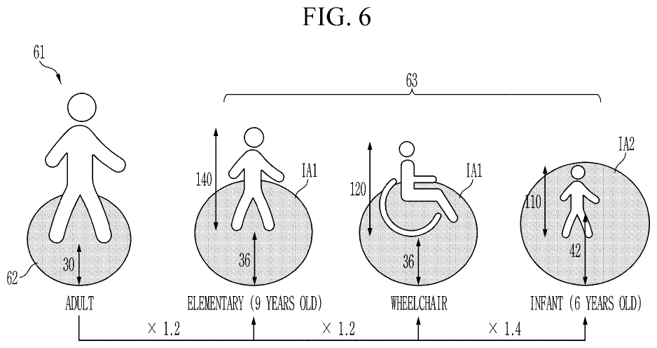

FIG. 6 is a diagram illustrating the expected collision range for each safety zone according to an embodiment of the present disclosure.

The apparatus 100 for generating a robot driving route plan may variably determine the type of safety zones based on the height of the specific object.

In FIG. 6, the human class may include an adult, a child (or a low grade), a wheelchair, and an infant.

In the case of the adult, since the height is 140 cm or more, it is determined as a human object 61. In the case of the child, the wheelchair, or the infant, since the height is smaller than 140 cm, it is determined as a specific object 63, which may be considered as a safety zone.

The apparatus 100 for generating a robot driving route plan may generate a first safety zone for an object having a height smaller than 120 cm and a second safety zone for an object having a height smaller than 110 cm among the specific objects 63. Here, the first safety zone may be generated for the wheelchair, and the second safety zone may be generated for the infant.

The apparatus 100 for generating a robot driving route plan may variably set the expected collision range according to the type of safety zones. The size of the expected collision range may be inversely proportional to the height of the specific object.

The expected collision range may be represented as a circular range with a radius of a specific size for the safety zone. For example, the size of the expected collision range 62 for the human object 61 may be a radius of 30 cm.

The expected collision range (inflated area) for the detection target may be a parameter set according to the size of the driving robot, the speed of the driving robot, and the shape of the driving robot.

Therefore, the expected collision range may vary at a specific magnification based on the safety zone.

The apparatus 100 for generating a robot driving route plan may generate a circular range with a radius of 36 cm for the wheelchair that is the first safety zone, as a first expected collision range IA1. The apparatus 100 for generating a robot driving route plan may generate a circular second expected collision range IA2 with a radius of 42 cm for the infant that is the second safety zone.

The first expected collision range IA1 may be determined to be 1.2 times the size of the expected collision range 62 for the human object 61. The size of the second expected collision range IA2 may be determined to be 1.4 times the size of the expected collision range 62 for the human object 61.

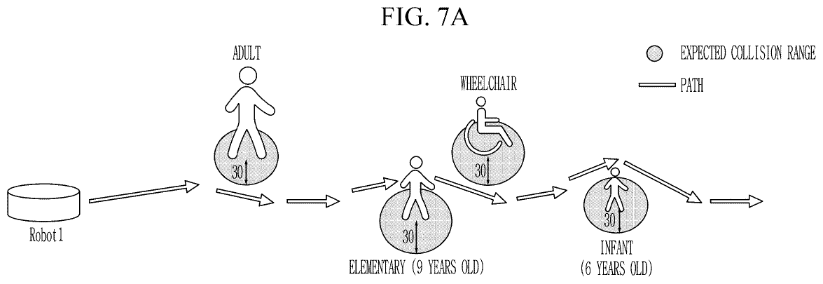

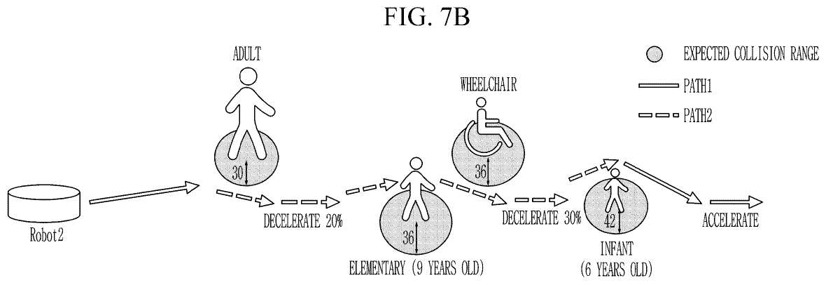

FIG. 7A illustrates an existing robot driving route plan according to Comparative Example. FIG. 7B illustrates a robot driving route plan according to an embodiment of the present disclosure.

In FIG. 7A, because the existing driving robot Robot1 does not generate a safety zone for transportation vulnerable, the expected collision range is determined to be the same range for the adult, the low grade, the wheelchair, and the infant.

In addition, the existing driving robot Robot1 does not reduce a driving speed for transportation vulnerable.

In other words, the existing driving robot Robot1 does not decelerate or detour according to the existing driving route plan even when passing over the object that is the transportation vulnerable. Therefore, the risk of collision between the driving robot and the transportation vulnerable may be high.

In FIG. 7B, the driving robot Robot2 drives according to the driving route plan generated by the apparatus 100 for generating a robot driving route plan according to an embodiment of the present disclosure.

The apparatus 100 for generating a robot driving route plan may set an extended expected collision range for the safety zone and may generate a second driving route plan that detours the extended expected collision range.

The apparatus 100 for generating a robot driving route plan may accelerate the driving speed of the driving robot while the driving robot is driving with the first driving route plan. The apparatus 100 for generating a robot driving route plan may decelerate the driving speed while the driving robot is driving with the second driving route plan.

The apparatus 100 for generating a robot driving route plan may variably determine the degree of deceleration of the driving speed of the driving robot in the second driving route plan based on the type of safety zone according to the height.

For example, the apparatus 100 for generating a robot driving route plan may reduce the driving speed by 20% for the safety zone that is the low grade. The apparatus 100 for generating a robot driving route plan may reduce the driving speed by 30% for the safety zone that is the infant.

The driving robot Robot2 drives according to the first driving route plan as before for the human object that is the adult.

However, the driving robot Robot2 drives according to a second driving route plan PATH2 in the safety zone generated for the low grade, the wheelchair, and the infant who are the transportation vulnerable.

For example, the driving robot Robot2 drives according to a first driving route plan PATH1 that accelerates the driving speed when it is not in the safety zone. The driving robot Robot2 drives according to the second driving route plan PATH2 that decelerates by 20% or 30% when it is in the safety zone.

In addition, the driving robot Robot2 avoids the human object according to the previously set expected collision range according to the first driving route plan when it is not in the safety zone. The driving robot Robot2 may drive by avoiding the safety zone based on the extended expected collision range according to the second driving route plan in the safety zone.

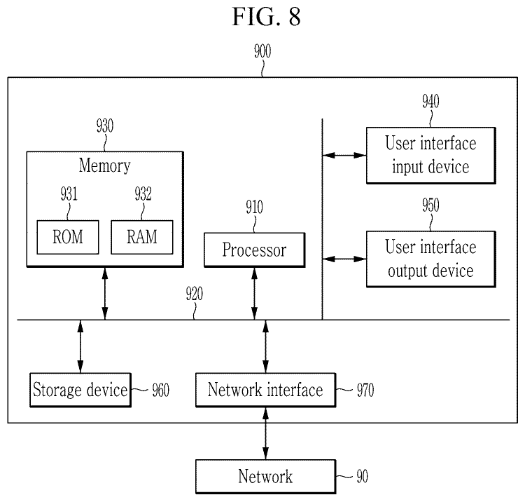

FIG. 8 is a diagram for describing a computing device according to an embodiment of present disclosure.

Referring to FIG. 8, the apparatus and method for generating a semantic map-based robot driving route plan for transportation vulnerable according to embodiments may be implemented using a computing device 900.

The computing device 900 may include at least one of a processor 910, a memory 930, a user interface input device 940, a user interface output device 950, and a storage device 960 that communicate via a bus 920. The computing device 900 may also include a network interface 970 that is electrically connected to a network 90. The network interface 970 may transmit or receive signals to and from other entities through the network 90.

The processor 910 may be implemented in various types, such as a micro controller unit (MCU), an application processor (AP), a central processing unit (CPU), a graphic processing unit (GPU), a neural processing unit (NPU). The driving robot Robot2 may be any semiconductor device that executes instructions stored in the memory 930 or the storage device 960. The processor 910 may be configured to implement the functions and methods described above with reference to FIGS. 1-7.

The memory 930 and the storage device 960 may include various types of volatile or non-volatile storage media. For example, the memory may include a read only memory (ROM) 931 and a random access memory (RAM) 932. In an embodiment of the present disclosure, the memory 930 may be located inside or outside the processor 910, and the memory 930 may be connected to the processor 910 through various means that are well-known.

In some embodiments, at least some components or functions of the apparatus and the method for generating a semantic map-based robot driving route plan for transportation vulnerable according to the embodiments may be implemented as a program or software running on the computing device 900, and the program or software may be stored on a computer-readable medium.

In some embodiments, at least some components or functions of the apparatus and the method for generating a semantic map-based robot driving route plan for transportation vulnerable according to the embodiments are implemented using hardware or circuits of the computing device 900. Alternatively, at least some components or functions of the apparatus and the method may be implemented as separate hardware or circuit that may be electrically connected to the computing device 900.

Although embodiments of the present disclosure have been described in detail hereinabove, the scope of the present disclosure is not limited thereto. Instead, the present disclosure may include modifications and alterations made by those having ordinary skill in the art to which the present disclosure pertains using a basic concept of the present disclosure as defined in the claims.

### DESCRIPTION OF SYMBOLS

100: Apparatus for generating semantic map-based robot driving route plan for transportation vulnerable
110: Semantic map generation unit
120: Safety zone generation unit
130: Driving route plan generation unit

What is claimed is:

1. An apparatus for generating a semantic map-based robot driving route plan for transportation vulnerable, the apparatus comprising:
a semantic map generation unit configured to generate a semantic map for an area where a driving robot is driving based on real-time location tracking data of the driving robot and semantic data on a surrounding environment;
a safety zone generation unit configured to:
calculate heights for a plurality of objects recognized while the driving robot is driving on the generated semantic map; and
generate a safety zone for a specific object determined to be the transportation vulnerable, among the plurality of objects, based on the calculated heights; and
a driving route plan generation unit configured to generate a second driving route plan different from a first driving route plan in real time for the safety zone when the safety zone is generated while the driving robot is driving with the first driving route plan.

2. The apparatus of claim 1, wherein the semantic map generation unit is further configured to:
generate the semantic map based on depth images obtained from a plurality of cameras, odometry of the driving robot estimated in real time from an IMU sensor, and a semantic image estimated from RGB images obtained from the plurality of cameras.

3. The apparatus of claim 1, wherein the safety zone generation unit is further configured to:
receive a semantic cloud generated from the semantic map;
classify the semantic cloud into an instance unit through clustering; and
calculate a height for a classified human class.

4. The apparatus of claim 3, wherein the safety zone generation unit is further configured to:
determine an object, having a height smaller than a preset specific reference value, as the specific object.

5. The apparatus of claim 4, wherein the safety zone generation unit is further configured to:
variably determine a type of the safety zone based on the height of the specific object.

6. The apparatus of claim 5, wherein the safety zone generation unit is further configured to:
generate a first safety zone for a first specific object having a height smaller than a first reference value among specific objects; and
generate a second safety zone for a second specific object having a height smaller than a second reference value among the specific objects, and
wherein the second reference value is smaller than the first reference value.

7. The apparatus of claim 5, wherein the driving route plan generation unit is further configured to:
set an expected collision range for the safety zone; and
generate the second driving route plan that detours the expected collision range.

8. The apparatus of claim 7, wherein the driving route plan generation unit is configured to:
variably set the expected collision range according to the type of the safety zone, and
wherein a size of the expected collision range is inversely proportional to the height of the specific object.

9. The apparatus of claim 1, wherein the driving route plan generation unit is configured to:
accelerate a driving speed of the driving robot while the driving robot is driving with the first driving route plan, and decelerates the driving speed while the driving robot is driving with the second driving route plan.

10. The apparatus of claim 9, wherein the driving route plan generation unit is configured to:
variably determine a degree of deceleration of the driving speed of the driving robot in the second driving route plan based on a type of the safety zone that varies based on a height of the specific object.

11. A method for generating a semantic map-based robot driving route plan for transportation vulnerable, the method comprising:
generating a semantic map for an area where a driving robot is driving based on real-time location tracking data of the driving robot and semantic data on a surrounding environment;
calculating heights for a plurality of objects recognized while the driving robot is driving on the generated semantic map;
generating a safety zone for a specific object determined to be the transportation vulnerable among the plurality of objects based on the calculated heights; and
generating a second driving route plan different from a first driving route plan in real time for the safety zone when the safety zone is generated while the driving robot is driving with the first driving route plan.

12. The method of claim 11, wherein generating the semantic map includes:
generating the semantic map based on depth images obtained from a plurality of cameras, odometry of the driving robot estimated in real time from an IMU sensor, and a semantic image estimated from RGB images obtained from the plurality of cameras.

13. The method of claim 11, wherein calculating the heights for the plurality of objects includes:
generating a semantic cloud from the semantic map;
classifying the semantic cloud into an instance unit through clustering; and
calculating a height for a classified human class.

14. The method of claim 13, wherein generating the safety zone includes:
determining an object, having a height smaller than a preset specific reference value, as the specific object.

15. The method of claim 14, wherein generating the safety zone further includes:
variably determining a type of the safety zone based on the height of the specific object.

16. The method of claim 15, wherein generating the safety zone further includes:
generating a first safety zone for a first specific object having a height smaller than a first reference value among specific objects; and
generating a second safety zone for a second specific object having a height smaller than a second reference value among the specific objects, and
wherein the second reference value is smaller than the first reference value.

17. The method of claim 15, wherein generating the second driving route plan in real time includes:
setting an expected collision range for the safety zone; and
generating the second driving route plan that detours the set expected collision range.

18. The method of claim 17, wherein generating the second driving route plan in real time further includes:
variably setting the expected collision range according to the type of the safety zone, and
wherein a size of the expected collision range is inversely proportional to the height of the specific object.

19. The method of claim 11, wherein generating the second driving route plan in real time includes:
accelerating a driving speed of the driving robot while the driving robot is driving with the first driving route plan; and
decelerating the driving speed while the driving robot is driving with the second driving route plan.

20. The method of claim 19, wherein generating the second driving route plan in real time further includes:
variably determining a degree of deceleration of the driving speed of the driving robot in the second driving route plan based on a type of the safety zone that varies depending on a height of the specific object.
